(19) United States
(12) Patent Application Publication
(10) Pub. No.: US 2011/0055769 A1
(43) Pub. Date: Mar. 3, 2011

(54) SYSTEM AND METHOD FOR PROVIDING THREE-DIMENSIONAL LOCATION IMAGE

(75) Inventor: Jong U. Lim, Seoul (KR)

(73) Assignee: PANTECH CO., LTD., Seoul (KR)

(21) Appl. No.: 12/832,681

(22) Filed: Jul. 8, 2010

(30) Foreign Application Priority Data
Aug. 26, 2009 (KR) 10-2009-0079279

(51) Int. Cl. G06F 3/048; G01S 19/42; G01C 19/02

(52) U.S. Cl. 715/851; 342/357.25; 73/504.08

(57) ABSTRACT

A system to provide a three-dimensional (3D) location image includes a Global Positioning System device to identify location data corresponding to image data generated by a camera, a transmission unit to transmit the image data and the location data to a 3D location information server, a receiving unit to receive location display data from the 3D location information server, a generation unit to generate 3D location image data using the location display data, and a providing unit to display the 3D location image data. A method for providing a 3D location image includes generating image data, identifying location data associated with the image, transmitting the image data and the location data to a 3D location information server, receiving location display data from the 3D location information server, and generating and displaying 3D location image data using the location display data and the image data.

### CROSS-REFERENCE TO RELATED APPLICATION

This application claims priority from and the benefit of Korean Patent Application No. 10-2009-0079279, filed on Aug. 26, 2009, which is hereby incorporated by reference for all purposes as if fully set forth herein.

### BACKGROUND FIELD OF THE DISCLOSURE

Exemplary embodiments of the present invention relate to a system and method for providing a three-dimensional (3D) location image.

### DISCUSSION OF THE BACKGROUND

Due to a development in communication technologies and a demand for a variety of services, a demand for an improved performance of a terminal may increase. For example, a conventional terminal may provide a simple voice call function or a message transmission/reception function. However, a more recent terminal may provide a video call function, a picture/moving picture photographing function, a Digital Multimedia Broadcasting (DMB) function, and the like.

Also, mobile communication companies provide services such as providing a path, route, or directions from a current location to a destination using a terminal based on a Location Based Service (LBS). That is, the LBS may provide a variety of services to a terminal user based on location information obtained using a mobile communication network or a Global Positioning System (GPS), either separate from or in connection with the mobile communication network and terminal.

FIG. 1 illustrates an example of providing the LBS in a location information server according to a related art.

As illustrated in FIG. 1, when a request for location information is received from a user, the location information server may receive GPS information from a terminal, and transmit, to the terminal, image information obtained by applying location information to a two-dimensional screen that is provided in advance based on the received GPS information.

That is, according to the related art, the location information may be an aerial view of the location captured by satellite in advance of the user's request, and therefore is displayed as an image that does not match a viewpoint of a user, thus failing to help the user to intuitively comprehend the location information, and also generating a limitation such as being displayed only on a two-dimensional screen.

Accordingly, there is a demand for a technique of displaying, in a more intuitively comprehensible manner, the location information using an image photographed by the user.

### SUMMARY

Exemplary embodiments of the present invention provide a system and a method for providing a three-dimensional (3D) location image, which may provide a 3D location image data obtained by overlapping location display data on image data generated by a user photographing an image.

Exemplary embodiments of the present invention also provide a system and a method for providing a 3D location image, which may transmit, to a 3D location information server, angle data obtained by a gravity sensor or direction data obtained by a gyro sensor, together with image data generated by a user photographing an image.

Additional features of the invention will be set forth in the description which follows, and in part will be apparent from the description, or may be learned by practice of the invention.

An exemplary embodiment of the present invention discloses a system to provide a 3D location image. The system includes: a location data device to identify location data associated with image data generated by a camera; a transmission unit to transmit the image data and the location data to a three-dimensional (3D) location information server; a receiving unit to receive location display data from the 3D location information server; a generation unit to generate 3D location image data using the location display data and the image data; and a providing unit to display the 3D location image data.

An exemplary embodiment of the present invention discloses a method for providing a 3D location image. The method includes: generating image data, identifying location data associated with the image data using a location data device, transmitting the image data and the location data to a 3D location information server; receiving location display data from the 3D location information server; generating 3D location image data using the location display data and the image data; and displaying the 3D location image data.

An exemplary embodiment of the present invention discloses a method for providing a 3D location image. The method includes: receiving image data and location data associated with the image data from a terminal; identifying location display data corresponding to the image data and the location data from a database; and transmitting the location display data to the terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates an example of providing a Location Based Service (LBS) in a location information server according to a related art.

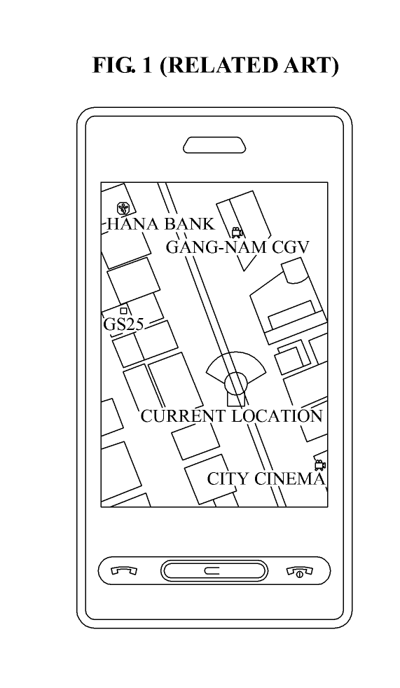

FIG. 2 illustrates a network connection relation of a system to provide a three-dimensional (3D) location image according to an exemplary embodiment of the present invention.

FIG. 3 is a block diagram illustrating a configuration of a system to provide a 3D location image according to an exemplary embodiment of the present invention.

FIG. 4 illustrates an example of image data generated by photographing an image, by a system to provide a 3D location image according to an exemplary embodiment of the present invention.

FIG. 5 illustrates an example of location display data received in a system to provide a 3D location image according to an exemplary embodiment of the present invention.

FIG. 6 illustrates an example of 3D location image data generated by a system to provide a 3D location image according to an exemplary embodiment of the present invention.

FIG. 7 illustrates an example of image data and description data provided by a system to provide a 3D location image according to an exemplary embodiment of the present invention.

FIG. 8 illustrates an example of image data and distance data provided by a system to provide a 3D location image according to an exemplary embodiment of the present invention.

FIG. 9 is a block diagram illustrating a configuration of a system to provide a 3D location image according to an exemplary embodiment of the present invention.

FIG. 10 illustrates an example of extracting a boundary of image data in a system to provide a 3D location image according to an exemplary embodiment of the present invention.

FIG. 11 illustrates an example of identifying location display data in a system to provide a 3D location image according to an exemplary embodiment of the present invention.

FIG. 12 is a flowchart illustrating a method for providing a 3D location image according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

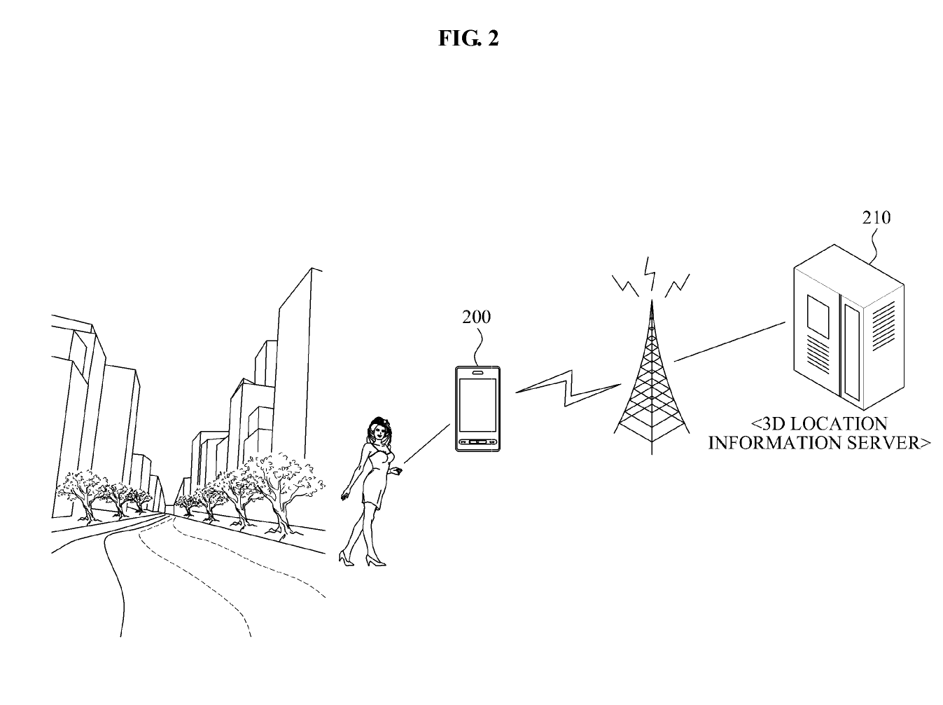

FIG. 2 illustrates a network connection relation of a system to provide a three-dimensional (3D) location image according to an exemplary embodiment of the present invention.

Referring to FIG. 2, a terminal 200 may include the system to provide 3D location image arranged therein, and implement a process of the system. The terminal 200 may photograph an image using a camera in accordance with a request of a user, thereby generating image data, and may identify location data using a location data device, such as a Global Positioning System (GPS) receiver, which may be separate or included in the terminal 200, and which may independently determine location data in conjunction with a plurality of GPS satellites (such as in an MS-based mode), or may determine or receive location data calculated at a base station of the mobile communication network (such as in an MS-assist mode). Hereinafter, the location data device will be described as a GPS device for convenience, but is not limited thereto. The terminal 200 may transmit the generated image data and the identified location data to a 3D location information server 210. In this instance, the terminal 200 may extract boundary data from the generated image data, and may transmit the extracted boundary data and the identified location data to the 3D location information server 210 instead of transmitting the image data.

The terminal 200 may receive an input of a destination from a user, and may transmit the inputted destination together with the generated image data and the identified location data to the 3D location information server 210. Alternatively, the terminal 200 may transmit angle data measured by a gravity sensor and direction data identified by a gyro sensor to the 3D location information server 210. These sensors may be included in the terminal 200 or may be separate.

The 3D location information server 210 may receive the image data and the location data from the terminal 200, and may identify the received image data and location display data matching the received location data from a database. The 3D location information server 210 may first identify, from the database, first location display data corresponding to the location data, and subsequently identify the location display data matching a boundary of the image data from among the first location display data. The 3D location information server 210 may transmit the identified location display data to the terminal 200.

The 3D location information server 210 may identify the received image data and the location display data matching the received location data based on the angle data or the direction data received from the terminal 200. The 3D location information server 210 may distinctively display the boundary matching the image data, generate the location display data including a destination, and transmit the generated location display data to the terminal 200.

The terminal 200 may receive the location display data, and generate 3D location image data using the received location display data and the generated image data. The terminal 200 may extract the destination and the boundary from the received location display data, associate the extracted destination with the boundary, and distinctively overlap the extracted boundary on the generated image data to thereby generate the 3D location image data. The terminal 200 may provide, i.e. display, the generated 3D location image data to a user.

The terminal 200 may calculate distance data from a current location to the destination using the identified location data and the inputted destination, and may provide the calculated distance data together with the 3D location image data to the user.

The terminal 200 may receive description data associated with the transmitted image data from the 3D location information server 210, and may provide the received description data together with the 3D location image data to the user.

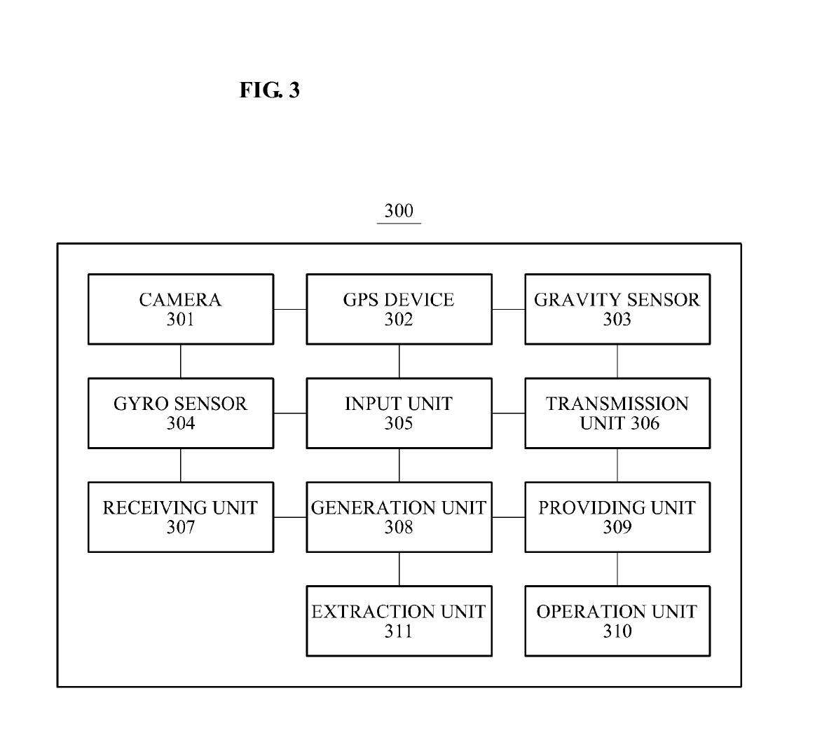

FIG. 3 is a block diagram illustrating a configuration of a system to provide a 3D location image according to an exemplary embodiment of the present invention.

As illustrated in FIG. 3, the system 300 to provide a 3D location image includes a camera 301, a GPS device 302, a gravity sensor 303, a gyro sensor 304, an input unit 305, a transmission unit 306, a receiving unit 307, a generation unit 308, a providing unit 309, an operation unit 310, and an extraction unit 311. The system 300 may be arranged in the terminal 200.

The camera 301 may be used to photograph an image in accordance with a request of the user, thereby generating the image data.

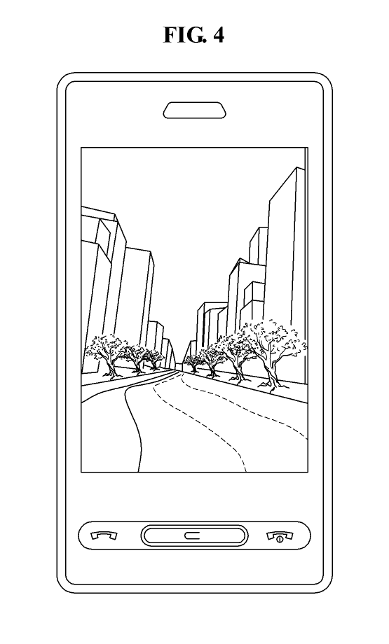

FIG. 4 illustrates an example of image data generated by photographing an image, by a system to provide a 3D location image according to an exemplary embodiment of the present invention.

As illustrated in FIG. 4, the image data may be generated using a camera 301 to photograph an image in accordance with a request of a user. That is, the image data may be data obtained by photographing a location where a user may recognize a destination in a current location.

When the image data is generated, the GPS device 302 may identify location data. The GPS device 302 may receive the location data from a GPS satellite or from a base station of the mobile communication network.

Transmission unit 306 may transmit the generated image data and the identified location data to the 3D location information server 210.

The input unit 305 may receive an input of the destination from the user. The destination may be a complete or partial address such as a block number, street name, a building name, a city name, a state name, or any portion or combination thereof, of the destination. The transmission unit 306 may transmit the inputted destination together with the generated image data and the location data to the 3D location information server 210. In this case, the 3D location information server 210 may more readily identify location display data corresponding to the image data and the location data using the destination.

The gravity sensor 303 may identify angle data associated with the generated image data. The gravity sensor 303 may identify the angle data based on inputs of the image data obtained when viewed from top, bottom, left, and right, and when viewed in a rotational manner. The gyro sensor 304 may identify direction data associated with the generated image data. The gyro sensor 304 may identify the direction data based on a speed when photographing the image. In this case, the transmission unit 306 may transmit the identified angle data or the identified direction data to the 3D location information server 210.

The extraction unit 311 may extract boundary data from the generated image data. In this instance, the boundary data may be data about a boundary of a building corresponding to the destination. For example, the boundary data may be employed when extracting the location display data in the 3D location information server 210. Accordingly, the transmission unit 306 may transmit the extracted boundary data together with the location data to the 3D location information server 210, instead of transmitting the image data. That is, the transmission unit 306 may transmit the extracted boundary data instead of the image data, and this may reduce a data transmission amount.

The receiving unit 307 may receive the location display data from the 3D location information server 210. The location display data may be data corresponding to the image data and the location data, and may include a boundary of the destination of the image data and the destination.

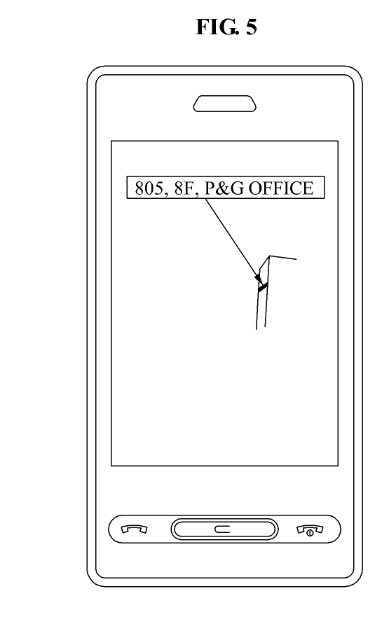

FIG. 5 illustrates an example of location display data received in a system to provide a 3D location image according to an exemplary embodiment of the present invention.

As illustrated in FIG. 5, the location display data may distinctively display a boundary (boundary data) of a building corresponding to a destination from among generated image data, and include an address (805, 8F, P&G office) of the destination.

The generation unit 308 may generate 3D location image data using the received location display data and the generated image data. The generation unit 308 may extract the destination and the boundary from the received location display data, associate the extracted destination with the boundary, and distinctively overlap the extracted boundary on the generated image data to generate the 3D location image data.

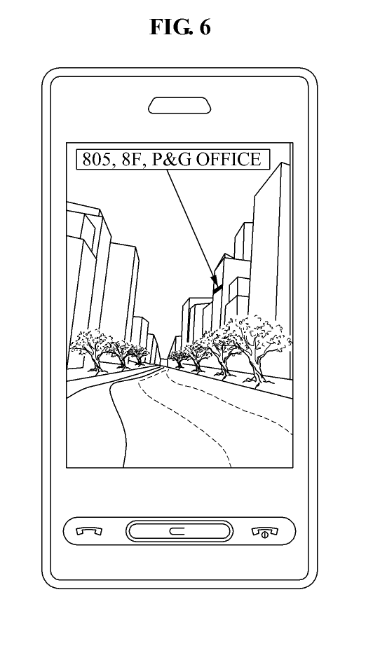

FIG. 6 illustrates an example of 3D location image data generated by a system to provide a 3D location image according to an exemplary embodiment of the present invention.

As illustrated in FIG. 6, the 3D location image data may be generated by overlapping location display data including a boundary and a destination on generated image data, that is, an image on a display screen of the terminal 200. The location display data may be generated to correspond to the image data, and the generation unit 308 may generate the 3D location image data by overlapping the received location display data on the generated image data. That is, the generation unit 308 may generate the 3D location image data by overlapping the boundary and the destination included in the location display data on the image data.

Referring to FIG. 6, the providing unit 309 may provide the generated 3D location image data to a user. Thus, the providing unit 309 may provide more intuitively comprehensible 3D location information that may be comprehended by the user since the 3D location image data includes the image data of the image captured by the user, and therefore displays a vantage that may be recognizable and comprehensible to the user.

The receiving unit 307 may receive description data associated with the transmitted image data from the 3D location information server 210, and the providing unit 309 may provide the received description data together with the 3D location image data to the user. The description data may be data describing the image data. For example, in a case of the image data concerning ‘Dabotop’, information about ‘Dabotop’ may be the description data.

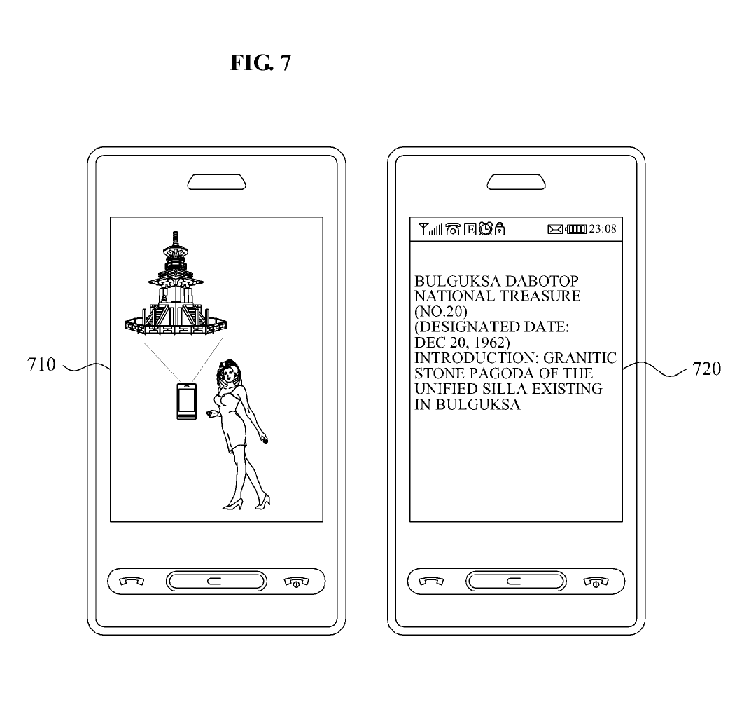

FIG. 7 illustrates an example of image data and description data provided by a system to provide a 3D location image according to an exemplary embodiment of the present invention.

As illustrated in FIG. 7, when ‘Dabotop’ of Bulguksa in Gyeong-ju is photographed by a user to generate image data 710, and the photographed ‘Dabotop’ is transmitted to the 3D location information server 210 as the image data 710, the 3D location information server 210 may transmit description data 720 to the system 300 to provide the 3D location image. For example, the description data 720 may include information about ‘Dabotop,’ such as National Treasure No. 20, introduction (existing in Bulguksa . . . the Period of Unified Silla) and the like, as descriptions about ‘Dabotop’.

When the image data 710 is ‘Namdaemun’, the description data 720 may include descriptions about ‘Namdaemun’. That is, the description data 720 may be information describing the image data 710 while corresponding to the image data 710 and the location data.

The operation unit 310 may calculate distance data from a current location to the destination using the identified location data and the inputted destination. Next, the providing unit 309 may provide the calculated distance data to the user.

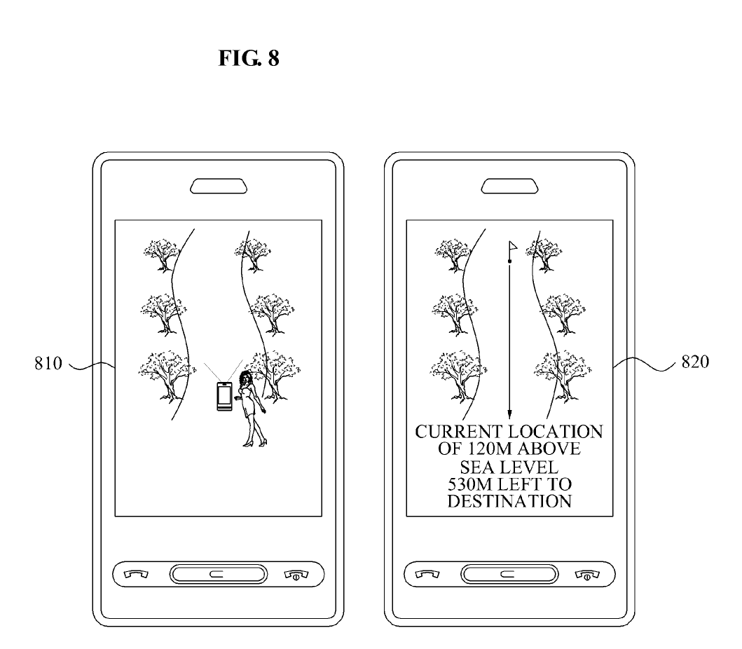

FIG. 8 illustrates an example of image data and distance data provided by a system to provide a 3D location image according to an exemplary embodiment of the present invention.

As illustrated in FIG. 8, if a user photographs a mountain trail to create image data 810, which may be difficult to be located, and transmits the photographed mountain trail together with location data to the 3D location information server 210, the 3D location information server 210 may transmit location display data (displayed as a flag) corresponding to the image data 810. In this instance, when receiving an input of a destination using the input unit 305, the operation unit 310 may determine the location data as a current location, and calculate distance data from the current location to the destination. In this case, the providing unit 309 may enable the distance data (current location of 120 M above sea level, 530 M left to destination) to be included in 3D location image data 820 generated by overlapping the location display data on the image data.

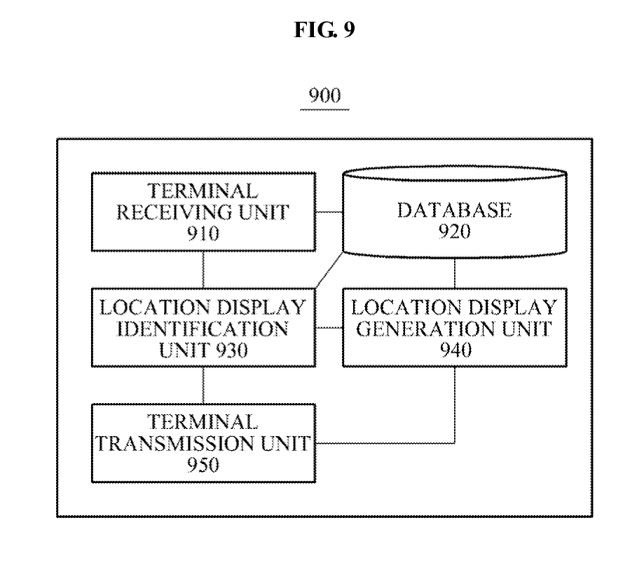

FIG. 9 is a block diagram illustrating a configuration of a system to provide a 3D location image according to an exemplary embodiment of the present invention.

As illustrated in FIG. 9, a system 900 to provide a 3D location image may include a terminal receiving unit 910, a database 920, a location display identification unit 930, a location display generation unit 940, and a terminal transmission unit 950. The system 900 may be partially or wholly included in the 3D location information server 210 to be implemented. For example, the database 920 could be arranged separately from the 3D location information server 210, but capable of transferred data between the 3D location information server 210 and the database 920.

The terminal receiving unit 910 may receive image data generated in the terminal 200 and location data. The terminal receiving unit 910 may further receive angle data and direction data that are identified in the terminal 200, or a destination inputted by a user. Alternatively, the terminal receiving unit 910 may receive boundary data in addition to or instead of the image data.

The location display identification unit 930 may identify location display data matching the received image data and location data from a database 920. For example, the location display identification unit 930 may extract a boundary of the image data, and identify the location display data using the extracted boundary and the location data. If the terminal receiving unit 910 receives the boundary data instead of the image data, the location display identification unit 930 may omit a process of extracting the boundary from the image data, and identify the location display data using the boundary data and the location data.

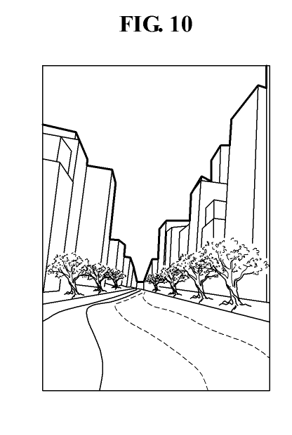

FIG. 10 illustrates an example of extracting a boundary of image data in a system to provide a 3D location image according to an exemplary embodiment of the present invention.

As illustrated in FIG. 10, the location display identification unit 930 may extract a boundary (boldly displayed) of a building of the image data, and identify the location display data matching the extracted boundary. In this instance, the location display identification unit 930 may first identify general location display data corresponding to the location data from the database 920, and subsequently identify more specific location display data matching the boundary of the image data from among the first identified general location display data.

The database 920 may include the location display data corresponding to the location data, and description data corresponding to the image data. The location display data may include a boundary of a destination, the destination, and the like. The description data may include information describing the image data.

The location display identification unit 930 may identify the location display data matching the received image data and location data based on the received angle data or the received direction data. That is, if the angle data or the direction data is further received, the location display identification unit 930 may identify the location display data based on the angle data or the direction data together with the image data and the location data.

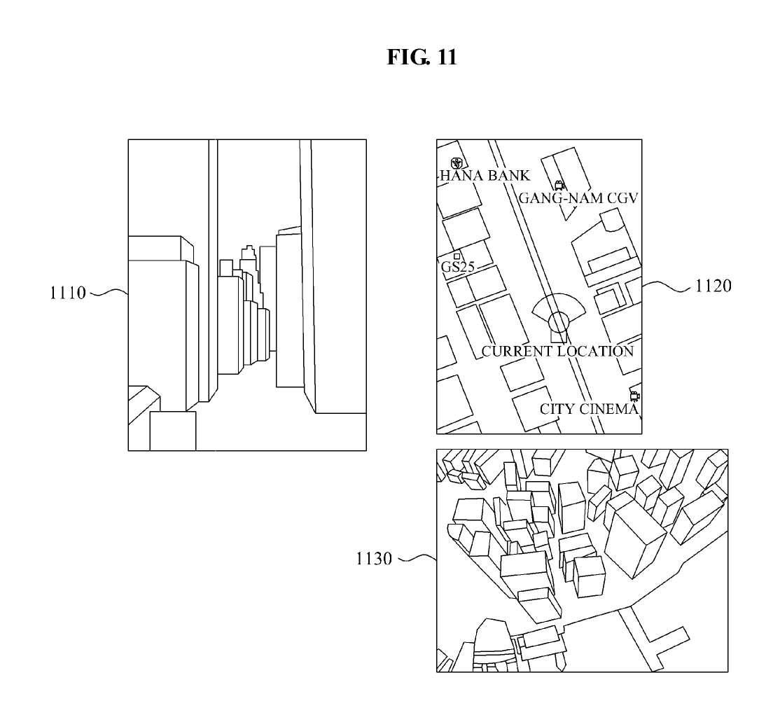

FIG. 11 illustrates an example of identifying location display data in a system to provide a 3D location image according to an exemplary embodiment of the present invention.

As illustrated in FIG. 11, the location display identification unit 930 may identify location display data 1110, 1120, and 1130 corresponding to image data and location data from the database 920. That is, to provide a 3D image, the location display identification unit 930 may identify the location display data 1110, 1120, and 1130 obtained when viewed from top, left, and right from the database 920.

The transmission unit 950 may transmit the identified location display data to the terminal 200.

The location display generation unit 940 may distinctively display the boundary matching the image data, and generate the location display data including a destination. The boundary may be matched with the boundary included in the image data, and the location display generation unit 940 may distinctively display a boundary of a building corresponding to the destination from other boundaries included in the image data. In this instance, the destination may correspond to 805, 8F, P&G office illustrated FIG. 6. The transmission unit 950 may transmit the generated location display data to the terminal 200.

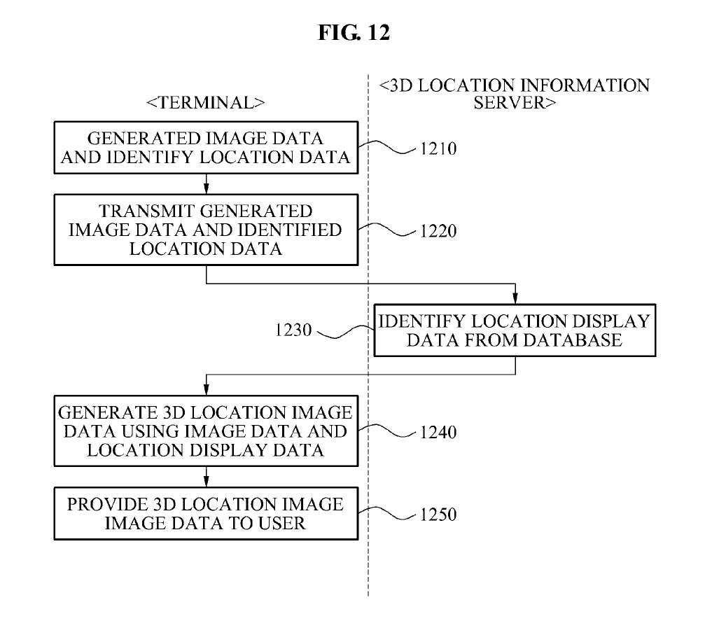

FIG. 12 is a flowchart illustrating a method for providing a 3D location image according to an exemplary embodiment of the present invention.

In operation 1210, the terminal 200 may identify location data when image data is generated by photographing an image using a camera. The terminal 200 may photograph the image data using a camera 301 included in the terminal 200 in accordance with a request of a user, and may identify location data using a GPS device 302 included in the terminal 200.

The terminal 200 may receive an input of a destination from the user, may measure angle data using a gravity sensor 303, or may identify direction data using a gyro sensor 304.

In operation 1220, the terminal 200 may transmit the generated image data and the identified location data to the 3D location information server 210. More specifically, the terminal 200 may transmit the inputted destination, the measured angle data, and the identified direction data together with the image data and the location data to the 3D location information server 210. Alternatively, the terminal 200 may extract boundary data from the image data, and transmit the extracted boundary data to the 3D location information server 210 instead of transmitting the image data.

In operation 1230, the 3D location information server 210 may receive the image data and the location data from the terminal 200, and identify location display data matching the received image data and location data from a database. The 3D location information server 210 may first identify the location display data corresponding to the location data from the database, and subsequently identify the location display data matching a boundary of the image data from among the first identified location display data. The 3D location information server 210 may transmit the identified location display data to the terminal 200.

The 3D location information server 210 may identify the location display data matching the received image data and location data based on the angle data or the direction data. The 3D location information server 210 may distinctively display the boundary matching the image data, generate the location display data including the destination, and transmit the generated location display data to the terminal 200.

When receiving the boundary data instead of the image data, the 3D location information server 210 may identify the location display data using the boundary data and the location data from the database.

In operation 1240, the terminal 200 may receive the location display data, and generate 3D location image data using the received location display data and the generated image data. The terminal 200 may extract a destination and a boundary from the received location display data, associate the extracted destination with the boundary, and distinctively overlap the extracted boundary on the generated image data to thereby generate the 3D location image data.

In operation 1250, the terminal 200 may provide the generated 3D location image data to the user. The terminal 200 may calculate distance data from a current location to the destination using the identified location data and the inputted destination, and provide the calculated distance data together with the 3D location image data to the user. The terminal 200 may receive description data associated with the transmitted image data from the 3D location information server 210, and provide the received description data together with the 3D location image data to the user.

The method for providing the 3D location image according to the above-described exemplary embodiments of the present invention may be recorded in computer-readable media including program commands to implement various operations embodied by a computer. The media may also include, alone or in combination with the program commands, data files, data structures, and the like. Examples of computer-readable media include magnetic media such as hard disks, floppy disks, and magnetic tape; optical media such as CD-ROM disks and DVDs; magneto-optical media such as optical disks; and hardware devices that are specially configured to store and perform program commands, such as read-only memory (ROM), random access memory (RAM), flash memory, and the like. Examples of program commands include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system to provide a three-dimensional (3D) location image, comprising:
a location data device to identify location data associated with image data generated by a camera;
a transmission unit to transmit the image data and the location data to a three-dimensional (3D) location information server;
a receiving unit to receive location display data from the 3D location information server;
a generation unit to generate 3D location image data using the location display data and the image data; and
a providing unit to display the 3D location image data.

2. The system of claim 1, further comprising:
an input unit to receive an input of a destination,
wherein the transmission unit transmits the destination to the 3D location information server.

3. The system of claim 1, further comprising:
a gravity sensor to measure angle data associated with the image data,
wherein the transmission unit transmits the angle data to the 3D location information server.

4. The system of claim 1, wherein the generation unit extracts a destination and a boundary from the location display data, associates the destination with the boundary, and overlaps the boundary on the image data to generate the 3D location image data.

5. The system of claim 1, wherein the receiving unit further receives description data associated with the image data from the 3D location information server, and the providing unit displays the description data.

6. The system of claim 1, further comprising:
a gyro sensor to identify direction data associated with the image data,
wherein the transmission unit transmits the direction data to the 3D location information server.

7. The system of claim 1, wherein the location data device comprises a Global Positioning System (GPS) receiver.

8. A method for providing a three-dimensional (3D) location image, comprising:
generating image data;
identifying location data associated with the image data using a location data device;
transmitting the image data and the location data to a 3D location information server;
receiving location display data from the 3D location information server;
generating 3D location image data using the location display data and the image data; and
displaying the 3D location image data.

9. The method of claim 8, wherein the transmitting includes:
receiving an input of a destination; and
transmitting the destination to the 3D location information server.

10. The method of claim 8, further comprising one of:
measuring angle data associated with the image data, and transmitting the angle data to the 3D location information server; and
identifying direction data associated with the image data, and transmitting the direction data to the 3D location information server.

11. The method of claim 8, further comprising:
extracting boundary data from the image data,
wherein transmitting the image data comprises transmitting the boundary data and the location data to the 3D location information server.

12. The method of claim 8, wherein generating 3D location image data comprises:
extracting a destination and a boundary from the location display data; and
associating the destination with the boundary, and overlapping the boundary on the image data to generate the 3D location image data.

13. The method of claim 8, wherein receiving location display data further comprises receiving description data associated with the image data from the 3D location information server.

14. A method for providing a three-dimensional (3D) location image, comprising:
receiving image data and location data associated with the image data from a terminal;
identifying location display data corresponding to the image data and the location data from a database; and
transmitting the location display data to the terminal.

15. The method of claim 14, further comprising:
receiving angle data or direction data associated with the image data,
wherein identifying location display data further comprises identifying the location display data based on the angle data or the direction data.

16. The method of claim 14, wherein identifying location display data further comprises:
identifying first location display data corresponding to the location data from the database; and
identifying second location display data corresponding to a boundary of the image data from among the first location display data.

17. The method of claim 14, wherein transmitting the location display data comprises:
displaying a boundary corresponding to the image data;
generating the location display data including a destination; and
transmitting the location display data including the destination to the terminal.
